(19) United States
(12) Patent Application Publication
(10) Pub. No.: US 2019/0172083 A1
(43) Pub. Date: Jun. 6, 2019

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Hiroshi IGATA, Yokohama-shi (JP); Shin SAKURADA, Toyota-shi (JP); Kuniaki JINNAI, Nagoya-shi (JP); Motoyoshi HATTA, Anjo-shi (JP); Shota HIROSE, Toyoake-shi (JP)

(73) Assignee: TOYOTA JIDOSHA KABUSHIKI KAISHA, Toyota-shi (JP)

(21) Appl. No.: 16/210,563

(22) Filed: Dec. 5, 2018

(30) Foreign Application Priority Data
Dec. 6, 2017 (JP) 2017-234410

(51) Int. Cl. G06Q 30/02; G06Q 30/06

(52) U.S. Cl. CPC G06Q 30/0206; G06Q 30/0223; G06Q 30/0645; G06Q 30/0238; G06Q 30/0235

(57) ABSTRACT

When returning an electric vehicle, a management server performs a process including: a step of specifying a return date and time and a user; a step of obtaining return station information; a step of setting a discount rate corresponding to a first difference between the number of electric vehicles that can be charged and the number of parked low-SOC vehicles; a step of setting a discount rate corresponding to prediction of increase or decrease of the number of electric vehicles at the time of returning; a step of setting a discount rate corresponding to a second difference between the number of electric vehicles that can be parked and the number of parked electric vehicles; and a step of setting a rental fee based on the set discount rates.

This nonprovisional application is based on Japanese Patent Application No. 2017-234410 filed on Dec. 6, 2017, with the Japan Patent Office, the entire contents of which are hereby incorporated by reference.

### BACKGROUND

### Field

The present disclosure relates to a setting of a rental fee of an electric vehicle.

### Description of the Background Art

Conventionally, a rental system has been known in which an electric vehicle is rented to a user and a rental fee is collected therefrom. In such a rental system, it is considered to utilize an electric vehicle in the following way: stations each serving as a site for renting electric vehicles are located at a plurality of locations, and a user drives an electric vehicle between stations. In such a way of utilization, it is considered to utilize an electric vehicle only for one-way trip, i.e., from one station to another station. Accordingly, electric vehicles may be unevenly distributed among the plurality of stations, thus failing to improve a utilization ratio.

To address such a problem, for example, Japanese Patent Laying-Open No. 2010-170283 discloses a technique for (i) requesting a user to drive an electric vehicle from a station in a densely parked state in which electric vehicles are densely parked to a station in a sparsely parked state in which electric vehicles are sparsely parked and (ii) paying a relevant consideration to the user.

### SUMMARY

In the case where the electric vehicle is rented as described above, a battery mounted in the electric vehicle has a decreased remaining amount of power when the electric vehicle is returned to a station. Hence, a certain charging time is secured. Accordingly, even though the variation in the number of electric vehicles among the stations may be addressed by adjusting a fee with attention being paid only to the number of electric vehicles in each station, when a battery of an electric vehicle parked in a station has a small remaining amount of power, the electric vehicle cannot be rented, with the result that the utilization ratio may be unable to be improved.

An object of the present disclosure is to provide an information processing device and an information processing method each for setting a rental fee of an electric vehicle to suppress decrease of a utilization ratio while suppressing uneven distribution of electric vehicles among stations when renting the electric vehicles.

An information processing device according to a certain aspect of the present disclosure is an information processing device for setting a rental fee of an electric vehicle in which a power storage device is mounted. The information processing device includes: a storage configured to store a first difference, the first difference being obtained by subtracting (i) the number of electric vehicles that are parked in a return station at a time of returning of the electric vehicle and that have power storage devices required to be charged, from (ii) the number of charging devices that are installed in the return station and that are configured to charge the power storage devices, the return station being a station to which the electric vehicle is returned among a plurality of stations serving as sites for renting electric vehicles; and a setting device configured to set the rental fee of the electric vehicle. When the first difference is larger than a predetermined number, the setting device is configured to set the rental fee to be smaller than the rental fee set when the first difference is smaller than the predetermined number.

In this way, as there are more availabilities for charging devices, the rental fee becomes smaller, thus motivating the user to set such a station as a return location for the electric vehicle. As a result, the user drives the electric vehicle to a station with availabilities for charging devices, whereby the power storage device mounted in the electric vehicle can be charged immediately. Accordingly, the utilization ratio can be suppressed from being decreased, while suppressing uneven distribution of vehicles among the stations.

In a certain embodiment, the setting device is configured to predict increase or decrease of the number of electric vehicles to be parked in the return station after the time of returning. When the number of electric vehicles to be parked in the return station after the time of returning is predicted to be decreased, the setting device is configured to set the rental fee to be smaller than the rental fee set when the number of electric vehicles to be parked in the return station after the time of returning is predicted to be increased.

In this way, since the rental fee is set to be smaller for the user who set, as the return location for the electric vehicle, the station predicted to be in the sparsely parked state, the user can be motivated to set such a station as the return location.

In a certain embodiment, the storage is configured to further store a second difference, the second difference being obtained by subtracting (i) the number of electric vehicles parked at the time of returning from (ii) the number of electric vehicles that can be parked in the return station. When the second difference is larger than a predetermined number, the setting device is configured to set the rental fee to be smaller than the rental fee set when the second difference is smaller than the predetermined number.

In this way, since the rental fee is set to be smaller for the user who returns the electric vehicle to the station that is in the sparsely parked state at the time of returning, the user can be motivated to set such a station as the return location.

In a certain embodiment, the information processing device further includes: a reservation receiving device configured to receive an reservation for renting the electric vehicle for a scheduled utilization period; and a notifying device configured to notify, in a closing period of the scheduled utilization period, a station which is included in a plurality of stations near the return station and for which the rental fee is predicted to be smaller than the rental fee set when the electric vehicle is returned to the return station. In this way, the user can be motivated to return the electric vehicle to a station predicted to be in the sparsely parked state in the closing period of the scheduled utilization period.

An information processing method according to another aspect of the present disclosure is an information processing method for setting a rental fee of an electric vehicle in which a power storage device is mounted. The information processing method includes: storing a first difference, the first difference being obtained by subtracting (i) the number of electric vehicles that are parked in a return station at a time of returning of the electric vehicle and that have power storage devices required to be charged, from (ii) the number of charging devices that are installed in the return station and that are configured to charge the power storage devices, the return station being a station to which the electric vehicle is returned among a plurality of stations serving as sites for renting electric vehicles; setting the rental fee of the electric vehicle; and when the first difference is larger than a predetermined number, setting the rental fee to be smaller than the rental fee set when the first difference is smaller than the predetermined number.

An information processing device according to still another aspect of the present disclosure is an information processing device for setting a rental fee of an electric vehicle in which a power storage device is mounted. The information processing device includes a setting device configured to set the rental fee of the electric vehicle. The setting device is configured to obtain the number of charging devices installed in a return station and configured to charge the power storage device, the return station being a station to which the electric vehicle is returned among a plurality of stations serving as sites for renting electric vehicles. The setting device is configured to calculate a first difference, the first difference being obtained by subtracting (i) the number of electric vehicles that are parked in the return station at a time of returning of the electric vehicle and that have power storage devices required to be charged, from (ii) the number of the charging devices. When the first difference is larger than a predetermined number, the setting device is configured to set the rental fee to be smaller than the rental fee set when the first difference is smaller than the predetermined number.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram of an information processing system according to the present embodiment.

FIG. 2 is a diagram showing an example of a configuration of an electric vehicle.

FIG. 3 is a flowchart showing a rental fee setting process.

FIG. 4 is a diagram for illustrating an exemplary discount rate set in accordance with the number of parked low-SOC vehicles at the time of returning.

FIG. 5 is a diagram for illustrating an exemplary discount rate set in accordance with prediction of increase or decrease of the number of parked electric vehicles at the time of returning.

FIG. 6 is a diagram for illustrating an exemplary discount rate set in accordance with the number of parked electric vehicles at the time of returning.

FIG. 7 is a flowchart showing a reservation receiving process.

### DESCRIPTION OF THE PREFERRED EMBODIMENTS

The following describes embodiments of the present disclosure with reference to figures in detail. It should be noted that the same or corresponding portions in the figures are given the same reference characters and are not described redundantly.

<As to Configuration of Rental Fee Setting System>

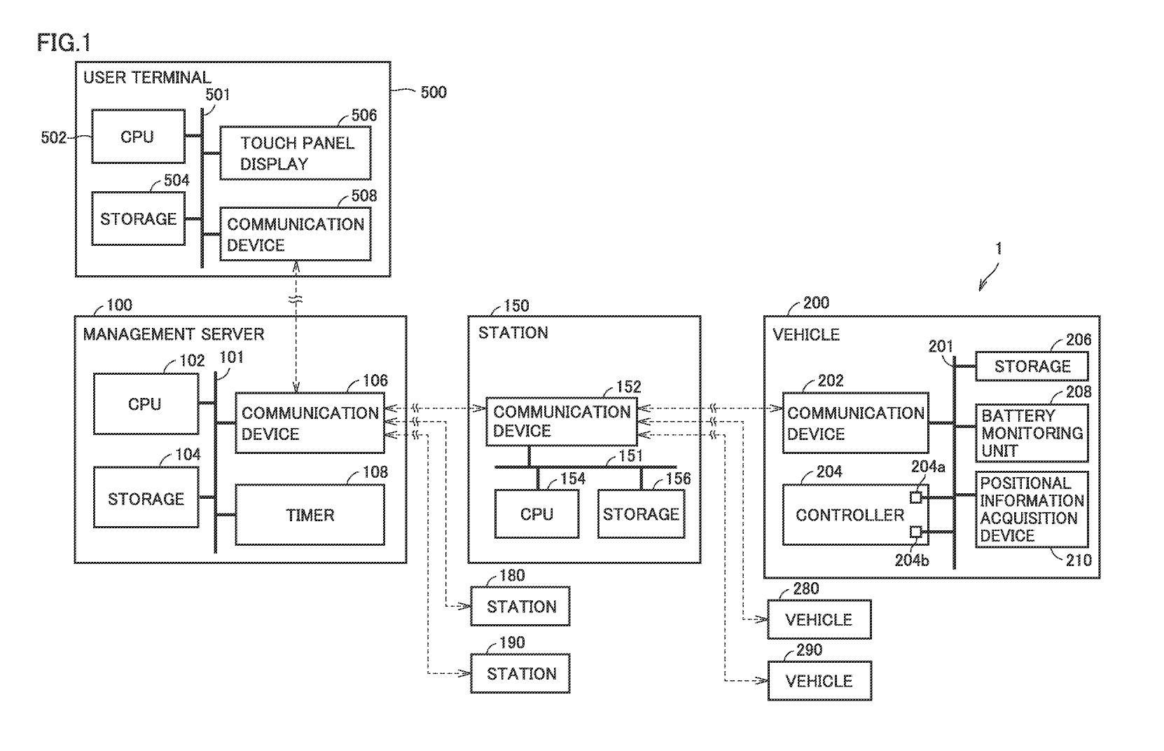

FIG. 1 is an overall configuration diagram of an information processing system 1 according to the present embodiment. As shown in FIG. 1, information processing system 1 according to the present embodiment includes: a management server 100; a station 150; vehicles 200, 280, 290 that are electric vehicles; and a user terminal 500.

Management server 100 includes a CPU (Central Processing Unit) 102, a storage 104, a communication device 106, and a timer 108. Each component is communicatively connected by a communication bus 101.

CPU 102 is configured to execute predetermined computation processing based for example on information stored in storage 104, or information received from station 150 or user terminal 500 via communication device 106.

Storage 104 includes, for example, a memory such as a ROM (Read Only Memory) and a RAM (Random Access Memory), and a large-capacity storage device such as a hard disk or a solid state drive. For example, storage 104 stores: information (a user list, a reservation list, or a utilization history) for associating the plurality of vehicles 200, 280, 290 with respective users of the vehicles; and information about stations 150, 180, 190 in which the plurality of vehicles 200, 280, 290 can be parked (for example, information about the locations of the stations, the respective numbers of electric vehicles parked in the stations, the respective numbers of charging devices installed in the stations, and the like).

Communication device 106 is configured to communicate with at least one of a communication device 152 of station 150 and a communication device 508 of user terminal 500, for example. For example, communication device 106 and communication device 152 communicate information with each other through wireless communication or wired communication. Communication device 106 and communication device 152 may communicate via a relay point (a wireless base station) or a predetermined communication network (for example, the Internet), or may not communicate via a relay point or a predetermined communication network. Moreover, communication device 106 is configured to similarly communicate with a station 180 and a station 190.

The wireless communications may be done in a wireless communication system capable of transmitting and receiving signals via a relay point utilizing a wireless LAN (Local Area Network) represented by IEEE 802.11, etc., or a wireless communication standard for a mobile phone such as 2G, 3G, 4G, 5G, etc., for example.

Communication between communication device 106 and communication device 508 is the same as the communication between communication device 106 and communication device 152; however, as the wireless communication system, for example, the following wireless communication system may be employed in addition to the above-described communication system: a wireless communication system capable of transmitting and receiving signals directly between communication device 106 and communication device 508 and utilizing a wireless communication standard such as Bluetooth (Registered trademark). It should be noted that a communication system between communication device 106 and communication device 508 may be the same as or different from the communication system between communication device 106 and communication device 152.

Timer 108 counts the current date and time. For example, CPU 102 stores in storage 104 a result of counting time by timer 108. When reading the current date and time from storage 104, CPU 102 may correct the current date and time by an externally received digital signal (standard radio wave) including date information and time information.

Station 150 includes communication device 152, a CPU 154, and a storage 156. Each component is communicatively connected by a communication bus 151.

Communication device 152 is configured to communicate with at least one of communication device 106 of management server 100 and communication device 202 of vehicle 200, for example. For example, communication device 152 and communication device 202 communicate information with each other through wireless communication. The wireless communication between communication device 152 and communication device 202 is the same as the wireless communication between communication device 106 and communication device 152 or communication device 508, and therefore will not be described in detail repeatedly.

CPU 154 is configured to execute predetermined computation processing based for example on information stored in storage 156, or information received from management server 100 or vehicle 200 via communication device 152.

For example, storage 156 includes: a memory such as ROM and RAM; and a large-capacity storage device such as a hard disk or a solid state drive. For example, storage 156 stores: information for specifying the station (for example, an intrinsic station ID given to the corresponding station); information for specifying the plurality of vehicles 200, 280, 290 parked in station 150; information received from the plurality of vehicles 200, 280, 290 (for example, respective pieces of SOC information of batteries mounted therein); and the like.

Station 150 relays communication between management server 100 and vehicle 200, and transmits, to management server 100, information for specifying station 150 in which vehicle 200 is parked. Accordingly, based on the information received from station 150, management server 100 can specify renting location and return location of vehicle 200.

It should be noted that stations 180, 190 have the same configurations as that of station 150. Accordingly, detailed description thereof will not be repeated.

Vehicle 200 includes communication device 202, a controller 204, a storage 206, a battery monitoring unit 208, and a positional information acquisition device 210. Each component is communicatively connected by a communication bus 201.

Communication device 202 is configured to communicate with communication device 152 of station 150, for example. Communication device 152 and communication device 202 wirelessly communicate as has been described above, and accordingly, how they do so will not be described redundantly.

Controller 204 includes, for example, a CPU 204a, a memory 204b (ROM and RAM), an input/output port for inputting and outputting various signals (not shown) and so forth. Controller 204 is configured to execute prescribed computation processing based on the information stored in memory 204b and storage 206, and information received from station 150 via communication device 202.

Storage 206 is a storage device that can store data of a larger size than memory 204b, and is, for example, a storage device composed of a nonvolatile memory, a hard disk, a solid state drive, or the like. For example, storage 206 stores a driving history of vehicle 200 (for example, a history of positional information (i.e., traveling route)), the SOC information, and the like.

Battery monitoring unit 208 detects a state of a battery 214 mounted in vehicle 200. Battery monitoring unit 208 detects, for example, battery 214's voltage, current and temperature. Battery monitoring unit 208 calculates an estimated value of the SOC of battery 214 by using for example the detected voltage, current and temperature of battery 214. The calculated estimated value of the SOC is stored in storage 206 as the SOC information. The SOC may be estimated using a well-known technique, and it will not be described specifically. Note that the SOC may be estimated by controller 204 rather than battery monitoring unit 208.

Positional information acquisition device 210 is configured to obtain the current position of vehicle 200. For example, positional information acquisition device 210 may obtain the current position of vehicle 200 by using GPS (Global Positioning System), or may obtain the current position of vehicle 200 by using positional information of a wireless communication device located outside vehicle 200 and capable of communicating with communication device 202. Positional information acquisition device 210 transmits to controller 204 a signal indicating the current position of vehicle 200 as obtained.

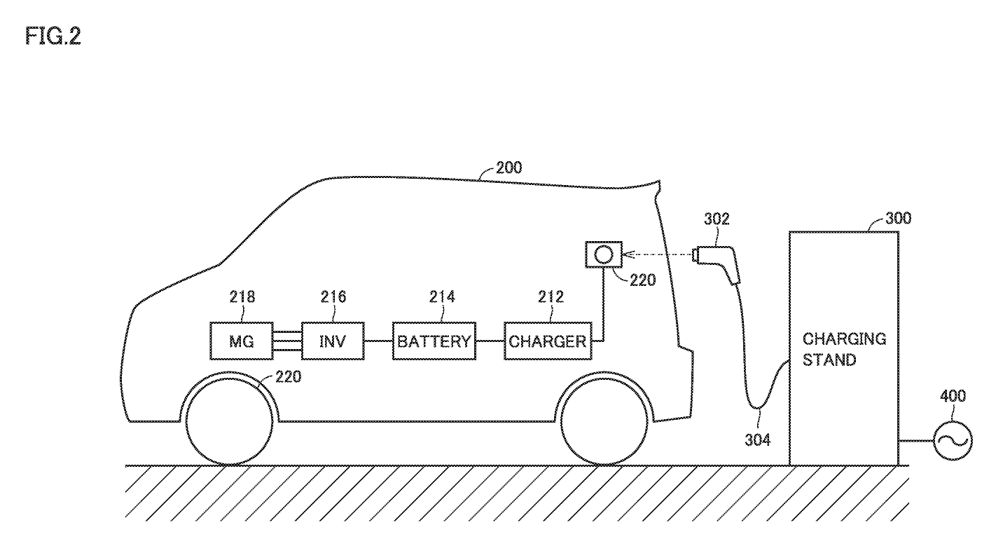

Vehicle 200 is an electric vehicle using an electric motor as a driving power source. FIG. 2 is a diagram showing an example of a configuration of an electric vehicle.

As shown in FIG. 2, vehicle 200 further includes a charger 212, battery 214, an inverter 216, a motor generator 218, and an inlet 220.

When a charging connector 302 of a charging stand 300 is attached to inlet 220, charger 212 charges battery 214 with power supplied from an external power supply 400.

Battery 214 is configured using, for example, a secondary battery such as a nickel-metal hydride battery or a lithium ion battery. Battery 214 may be any power storage device capable of storing power, and for example, a large-capacity capacitor may be used instead of battery 214.

Inverter 216 is a power conversion device which converts power between AC power and DC power. Inverter 216 may for example convert DC power of battery 214 into AC power and supply it to motor generator 218. Further, inverter 216 may for example receive AC power (regenerative power) from motor generator 218, convert it into DC power, and supply it to battery 214 to electrically charge battery 214 therewith.

Motor generator 218 receives power supplied from inverter 216 and provides rotational force to a drive wheel 222. Drive wheel 222 is rotated by the rotational force provided by motor generator 218 to drive vehicle 200.

Inlet 220 is provided in vehicle 200 at an exterior portion of vehicle 200 together with a cover (not shown) such as a lid. Inlet 220 has a shape allowing charging connector 302 to be attached thereto. Inlet 220 and charging connector 302 both have contacts, respectively, incorporated therein, and when charging connector 302 is attached to inlet 220, the contacts come into contact with each other, and inlet 220 and charging connector 302 are thus electrically connected together.

Charging stand 300 is a charging device installed outside vehicle 200 and connected to charging connector 302 via a charging cable 304. Charging stand 300 is electrically connected to power supply 400, and when charging connector 302 is attached to inlet 220, the power of power supply 400 is supplied via charging stand 300, charging cable 304, and charging connector 302 to vehicle 200. Charging stand 300 is provided in at least one of stations 150, 180, 190, for example. In each of stations 150, 180, 190, the predetermined number of charging stands 300 are installed.

Vehicles 280 and 290 are similar in configuration to vehicle 200. Accordingly, they will not be described redundantly.

User terminal 500 includes a CPU 502, a storage 504, a touch panel display 506, and a communication device 508. Each component is communicatively connected by a communication bus 501. As user terminal 500, a mobile phone such as a smartphone is used, for example.

CPU 502 is configured to execute predetermined computation processing based for example on information stored in storage 504, or information received from management server 100 via communication device 508. Storage 504 is constituted of a memory, such as ROM and RAM, for example.

Touch panel display 506 is constructed by providing a touch panel on a surface of a display screen of a liquid crystal display. Touch panel display 506 transmits, to CPU 502, an operation signal resulting from an operation performed onto the touch panel by the user. The liquid crystal display of touch panel display 506 presents an image based on a control signal from CPU 502. It should be noted that touch panel display 506 may be configured such that an input device such as a keyboard or a mouse and the display device such as the liquid crystal display may be provided separately.

Communication device 508 is configured to communicate with communication device 106 of management server 100, for example. Communication device 508 and communication device 106 wirelessly communicate as has been described above, and accordingly, how they do so will not be described redundantly.

For example, the user can use user terminal 500 to make a reservation to rent one of vehicles 200, 280, 290 during a period during which the user is to utilize the vehicle.

<As to Reservation Receiving Process>

User terminal 500 creates reservation information in accordance with an operation of the user onto touch panel display 506, for example. User terminal 500 transmits the created reservation information to management server 100 via communication device 508.

Management server 100 receives the reservation information from user terminal 500. For example, the reservation information includes: information (user ID) for specifying the user; information (station ID) for specifying a station serving as a departure location; information for specifying a station serving as a return location (destination); date and time of start of utilization of the electric vehicle; and scheduled return date and time of the electric vehicle. When management server 100 receives the reservation information from user terminal 500, management server 100 updates the reservation list based on the reservation information. The reservation list includes: the information (user ID) for specifying the user; the information (station ID) for specifying the station serving as the departure location; the information for specifying the station serving as the return location (destination); the date and time of start of utilization of the electric vehicle; the scheduled return date and time of the electric vehicle; and information (for example, numbers described in the license plate or the like) for specifying the vehicle to be rented. For example, management server 100 sets, as the vehicle to be rented, an electric vehicle that is parked at the station serving as the departure location and that has a battery having a SOC with which the vehicle at least can travel to the station serving as the return location. Management server 100 stores the updated reservation list into storage 104. Moreover, management server 100 transmits, to user terminal 500 via communication device 106, the information for specifying the vehicle to be rented, before the date and time of start of utilization thereof.

<As to Utilization Manner of Electric Vehicle>

In the present embodiment, as the utilization manner of the electric vehicle, for example, the user can select one of the following utilization manners: a utilization manner (lease) in which the electric vehicle is rented until a predetermined contract period (one year or a plurality of years) passes; a utilization manner (rental) in which a fee per unit time is set and a rental fee corresponding to a time of utilization is collected when returning the electric vehicle; and a utilization manner (sharing) in which a plurality of persons shares one electric vehicle or two or more electric vehicles until a predetermined contract period passes.

For example, when the electric vehicle is utilized in the rental type utilization manner of these utilization manners, a rental fee corresponding to the utilization may be set when returning vehicle 200. Alternatively, for example, when the electric vehicle is utilized in the lease type utilization manner, a leasing fee for each predetermined period (for example, one month) may be set. Alternatively, for example, when the electric vehicle is utilized in the sharing type utilization manner, a total of a fee for each predetermined period and a fee corresponding to the utilization may be set as a sharing fee.

In the rental system for the electric vehicle utilized in each of such utilization manners, it is considered to utilize the electric vehicle in the following way: stations each serving as a site for renting electric vehicles are located at a plurality of locations, and a user drives an electric vehicle between stations. In such a way of utilization, it is considered to utilize an electric vehicle only for one-way trip, i.e., from one station to another station. Accordingly, electric vehicles may be unevenly distributed among the plurality of stations, thus failing to improve a utilization ratio.

Moreover, in the case where an electric vehicle is rented, a battery mounted in the electric vehicle has a decreased remaining amount of power when the electric vehicle is returned to the station. Hence, a certain charging time is secured. Accordingly, even though the variation in the number of electric vehicles among the stations may be addressed by adjusting a fee with attention being paid only to the number of electric vehicles in each station, when a battery of an electric vehicle parked in a station has a small remaining amount of power, the electric vehicle cannot be rented or the number of electric vehicles that can be rented is limited, with the result that the utilization ratio may be unable to be improved.

To address this, in the present embodiment, management server 100 is configured to store a first difference, the first difference being obtained by subtracting (i) the number of electric vehicles that are parked in a return station at the time of returning of an electric vehicle and that have mounted batteries required to be charged, from (ii) the number of charging stands installed in the return station, wherein when the first difference is larger than a predetermined number, management server 100 is configured to set the rental fee to be smaller than the rental fee set when the first difference is smaller than the predetermined number. In the present embodiment, management server 100 corresponds to an “information processing device”.

In this way, as there are more availabilities for charging stands, the rental fee becomes smaller, thus motivating the user to set such a station as a return location for the electric vehicle. As a result, the user drives the electric vehicle to a station with availabilities for charging stands, whereby the power storage device mounted in the electric vehicle can be charged immediately. Accordingly, the utilization ratio can be suppressed from being decreased, while suppressing uneven distribution of vehicles among the stations.

<As to Renting Process in Management Server 100>

For example, by receiving predetermined information from a vehicle to be rented (hereinafter, referred to as “rented vehicle”) via a station, management server 100 specifies the rented vehicle, date and time upon the renting (hereinafter, referred to as “renting date and time”), the user, the renting location, and the SOC of the battery mounted in the rented vehicle, and stores the respective pieces of specified information in storage 104 in association with one another.

For example, management server 100 specifies, as the renting date and time, date and time on which the predetermined information is received. Moreover, for example, management server 100 specifies, as the renting location, the station having transmitted the predetermined information.

For example, the predetermined information includes: renting information indicating that a renting operation has been performed in the rented vehicle; user specifying information for specifying the user; information for specifying the rented vehicle; and SOC information indicating the SOC of battery 214 at the time of start of utilization. The renting operation includes an operation of unlocking a door of the rented vehicle, for example.

Storage 104 of management server 100 stores identification information of the user who has made utilization registration. The user who has made utilization registration is given a card key including a storage medium having the identification information stored therein, for example. When the user performs a reading operation by, for example, holding the card key over a card reader provided in the rented vehicle, the door of the rented vehicle is unlocked by an actuator and the identification information is read from the card key. When the door is unlocked, the rented vehicle transmits the information for specifying the rented vehicle and the identification information read from the card key, to management server 100 via the station as the user specifying information. When the door is unlocked, the rented vehicle calculates the SOC of battery 214, and transmits the calculated SOC as the SOC information to management server 100 via the station together with other information.

<As to Setting of Rental Fee>

At the time of returning of the rented vehicle, management server 100 specifies the return station as well as the date and time (return date and time), and calculates a utilization period from the renting date and time and the return date and time. Management server 100 sets the rental fee by multiplying the calculated utilization period by a unit fee per predetermined time period (for example, fee per hour).

Management server 100 obtains a situation of the return station, and sets a discount rate based on the obtained situation of the return station. Management server 100 calculates a discount amount by multiplying the set discount rate by the rental fee, and sets, as a final rental fee, a fee obtained by subtracting the calculated discount amount from the yet-to-be-discounted rental fee.

<As to Rental Fee Setting Process>

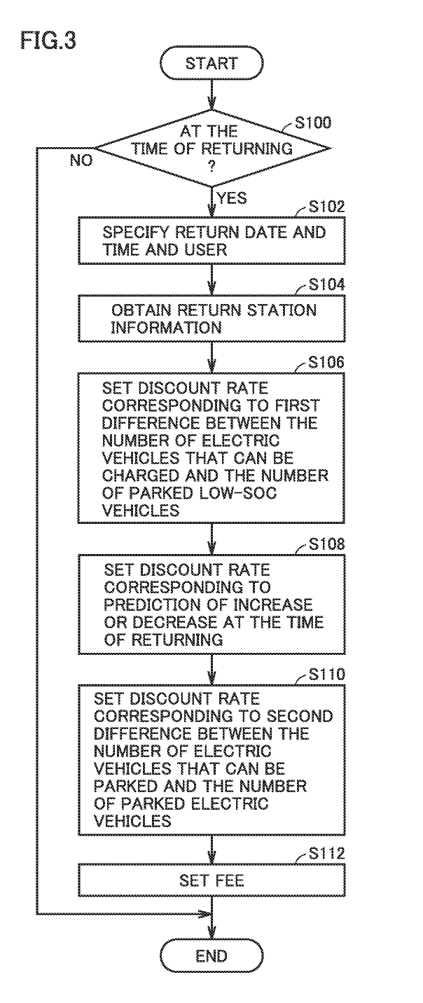

Hereinafter, a rental fee setting process will be described in detail with reference to FIG. 3. FIG. 3 is a flowchart showing the rental fee setting process. In the present embodiment, the rental fee setting process will be described as being executed by management server 100 (more specifically, CPU 102 of management server 100) for the sake of illustration. While each step shown in the flowchart shown in FIG. 3 is implemented by software processing done by management server 100, a part thereof may be implemented by hardware (or electric circuitry) fabricated in management server 100. Regarding the below-described process, it may be illustratively described that vehicle 200 is returned to station 150.

In a step (the term “step” will be hereinafter abbreviated as “S”) 100, management server 100 determines whether or not the rented electric vehicle has been returned.

For example, management server 100 may determine that the rented electric vehicle has been returned, when receiving, from vehicle 200 via station 150, (i) user information for specifying the user or the vehicle and (ii) return information indicating that a returning operation has been performed onto vehicle 200. The returning operation includes an operation of parking vehicle 200 in return station 150 and locking the door, for example. The operation of locking the door includes an operation of holding the card key over the card reader of vehicle 200, for example. When the card key is held over the card reader, vehicle 200 performs a locking operation by operating the actuator to lock the door, and performs an operation of reading information from the card key via the card reader. Vehicle 200 transmits, as the user information, the identification information read from the card key and the return information to management server 100 via station 150.

Alternatively, management server 100 may determine that the rented electric vehicle has been returned, when the user information and the return information are received from station 150 as a result of an operation by an administrator of return station 150, for example.

It should be noted that the method for determining whether or not the electric vehicle has been returned as described above is exemplary, and is not particularly limited to those described above. When it is determined that the rented electric vehicle has been returned (YES in S100), the process proceeds to S102.

In S102, management server 100 specifies the return date and time and the user. Specifically, management server 100 obtains the return date and time from the received return information, and obtains the user ID from the user information, thereby specifying the return date and time and the user.

In S104, management server 100 obtains return station information. The return station information is information for specifying the location of the return station, and includes: a station ID provided for the corresponding station; information about the number of rental electric vehicles in the return station; and information about the SOCs of the respective batteries mounted in the electric vehicles parked in the return station. Storage 104 of management server 100 stores information for associating the station ID with the location of the station. Management server 100 receives, as the return station information, the station ID transmitted from station 150 during communication with station 150, for example.

In S106, management server 100 sets a discount rate corresponding to the first difference between the number of electric vehicles that can be charged and the number of parked low-SOC vehicles. Specifically, as the number of electric vehicles that can be charged, management server 100 obtains the total number of charging stands installed in the return station. As the number of parked low-SOC vehicles required to be charged, management server 100 obtains the number of parked electric vehicles having batteries with SOCs less than or equal to a threshold value, among the electric vehicles parked in the return station. Management server 100 sets a discount rate corresponding to the first difference obtained by subtracting the number of parked low-SOC vehicles from the number of electric vehicles that can be charged. When the first difference is larger than a predetermined number, management server 100 sets the discount rate such that the rental fee becomes smaller than that in the case where the first difference is smaller than the predetermined number.

The total number of charging stands in each station is beforehand associated with a corresponding station ID, and is stored as a map in storage 104 of management server 100. Hence, management server 100 uses the station ID of the return station and the map to obtain the number of electric vehicles that can be charged. The respective pieces of SOC information of the electric vehicles parked in the return station are received from the return station by management server 100 as the return station information. The management server uses the received return station information to calculate the number of the low-SOC vehicles.

Management server 100 sets a discount rate A(1) corresponding to the first difference obtained by subtracting the number of parked low-SOC vehicles from the obtained number of electric vehicles that can be charged. For example, when the first difference is larger than the predetermined number, discount rate A(1) is set to have a value larger than that of discount rate A(1) set when the first difference is smaller than the predetermined number. When the first difference is larger than the predetermined number, it is indicated that there are many availabilities for charging stands. Accordingly, charging of the battery can be started immediately after the returning of the electric vehicle, thereby contributing to improvement in the utilization ratio. By increasing the discount rate for the user who returns the electric vehicle to such a station, the user can be motivated to return the electric vehicle to the station that can perform charging immediately.

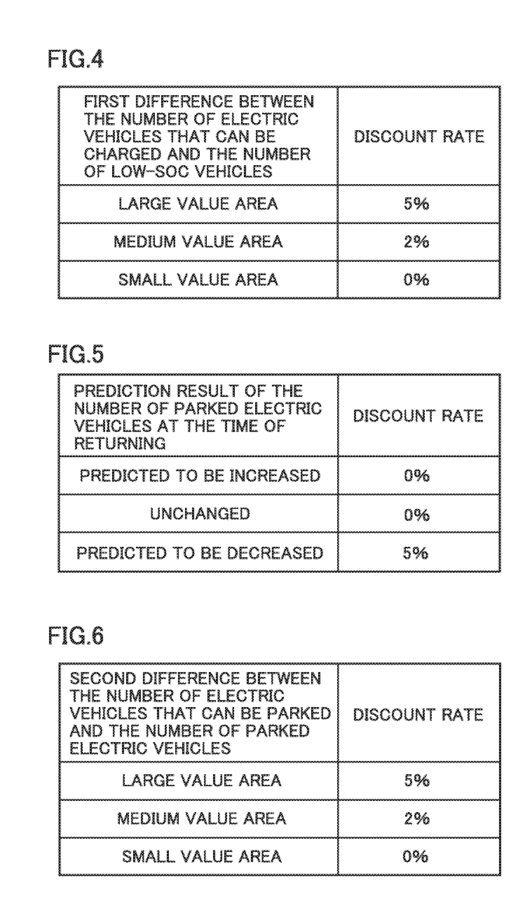

FIG. 4 is a diagram for illustrating an exemplary discount rate set in accordance with the number of parked low-SOC vehicles at the time of returning. As shown in FIG. 4, for example, first differences are classified by a plurality of threshold values (e.g., a first threshold value for dividing a large value area and a medium value area and a second threshold value for dividing the medium value area and a small value area) into the large, medium and small value areas, and a map in which a discount rate is set for each classification is previously stored in storage 104. Management server 100 makes reference to the map to set a different discount rate A(1) depending on what classification the first difference at the time of returning corresponds to.

For example, when the value of the difference at the time of returning falls within the large value area, management server 100 sets a discount rate A(1) of 5%. On the other hand, when the value of the difference at the time of returning falls within the medium value area, management server 100 sets a discount rate A(1) of 2%. On the other hand, when the value of the difference at the time of returning falls within the small value area, management server 100 sets a discount rate A(1) of 0%. The numerical values of discount rates A(1) to A(3) described above and below are mere examples and are not a limitation. Furthermore, while discount rates A(1) and A(3) described above and below are described by referring as one example to a case of setting them in three stages, they may be set in a plurality of stages such as two or four or more stages.

Returning to FIG. 3, in S108, management server 100 sets discount rate A(2) corresponding to prediction of increase or decrease of the number of parked electric vehicles at the time of returning. Specifically, management server 100 makes reference to a reservation status of the return station in the reservation list so as to compare (i) the number of electric vehicles scheduled to leave until passage of a predetermined period (for example, several hours or several days) from the time of returning with (ii) the number of electric vehicles scheduled to enter (the number of electric vehicles scheduled to be returned) until passage of the predetermined period from the time of returning. When the number of electric vehicles scheduled to leave is larger than the number of electric vehicles scheduled to enter, the number of parked electric vehicles after the time of returning is predicted to be decreased. On the other hand, when the number of electric vehicles scheduled to leave is smaller than the number of electric vehicles scheduled to enter, the number of parked electric vehicles after the time of returning is predicted to be increased. Moreover, when the number of electric vehicles scheduled to leave is the same as the number of electric vehicles scheduled to enter, the number of parked electric vehicles after the time of returning is predicted to be unchanged. For example, management server 100 calculates, as the number of electric vehicles scheduled to leave, the number of reservations for which the dates and times of start of utilization are reached until passage of the predetermined period from the time of returning. For example, management server 100 calculates, as the number of electric vehicles scheduled to enter, the number of reservations for which the scheduled return dates and times are reached until passage of the predetermined period from the time of returning.

Management server 100 sets discount rate A(2) corresponding to a magnitude relation between the number of electric vehicles scheduled to leave and the number of electric vehicles scheduled to enter. When the number of parked electric vehicles after the time of returning is predicted to be decreased, discount rate A(2) is set to have a value larger than the value of discount rate A(2) set when the number of parked electric vehicles after the time of returning is predicted to be increased. When the number of parked electric vehicles after the time of returning is predicted to be decreased, it is predicted that there will be a margin for spaces to park electric vehicles and that the station will be in the sparsely parked state. To address this, by increasing the discount rate, the user can be motivated to return the electric vehicle to the station predicted to be in the sparsely parked state.

FIG. 5 is a diagram for illustrating an exemplary discount rate set in accordance with prediction of increase or decrease of the number of parked electric vehicles at the time of returning. As shown in FIG. 5, classifications are made as follows: a case where the number of parked electric vehicles after the time of returning is predicted to be increased; a case where the number of parked electric vehicles after the time of returning is predicted to be unchanged; and a case where the number of parked electric vehicles after the time of returning is predicted to be decreased. A map in which discount rates are set for the respective classifications is stored in storage 104 in advance. Management server 100 makes reference to the prediction result and the map to set a different discount rate A(2) depending on what classification the prediction result corresponds to.

For example, in the case where the number of parked electric vehicles after the time of returning is predicted to be increased and in the case where the number of parked electric vehicles after the time of returning is predicted to be unchanged, management server 100 sets a discount rate A(2) of 0%. On the other hand, in the case where the number of parked electric vehicles after the time of returning is predicted to be decreased, management server 100 sets a discount rate A(2) of 5%.

Returning to FIG. 3, in S110, management server 100 sets discount rate A(3) corresponding to a second difference between the number of electric vehicles that can be parked in the return station and the number of parked electric vehicles in the return station. Specifically, management server 100 calculates the second difference obtained by subtracting (i) the number of rental electric vehicles parked at the time of returning from (ii) the upper limit value of the number of rental electric vehicles parked in the return station (that is, the number of electric vehicles that can be parked therein). When the second difference is larger than a predetermined number, management server 100 sets the discount rate such that the rental fee becomes smaller than that in the case where the second difference is smaller than the predetermined number.

The number of electric vehicles that can be parked in each station is associated with a corresponding station ID in advance, and is stored in storage 104 of management server 100 as a map. Hence, management server 100 uses the station ID of the return station and the map to obtain the number of electric vehicles that can be parked. Information of the number of electric vehicles parked in the return station is received by management server 100 from the return station as the return station information.

Management server 100 sets discount rate A(3) corresponding to the second difference obtained by subtracting (i) the number of electric vehicles parked in the return station from (ii) the obtained number of electric vehicles that can be parked therein. For example, when the second difference is larger than the predetermined number, discount rate A(3) is set to have a value larger than that of discount rate A(3) set when the second difference is smaller than the predetermined number. When the second difference is larger than the predetermined number, it is indicated that there is a margin for spaces to park electric vehicles and that the station is in the sparsely parked state. Hence, by increasing the discount rate for the user who returns the electric vehicle to such a station, the user can be motivated to return the electric vehicle to the station that is in the sparsely parked state.

FIG. 6 is a diagram for illustrating an exemplary discount rate set in accordance with the number of electric vehicles parked at the time of returning. As shown in FIG. 6, for example, second differences are classified by a plurality of threshold values (e.g., a first threshold value for dividing a large value area and a medium value area and a second threshold value for dividing the medium value area and a small value area) into the large, medium and small value areas, and a map in which a discount rate is set for each classification is previously stored in storage 104. Management server 100 makes reference to the map to set a different discount rate A(3) depending on what classification the second difference at the time of returning corresponds to.

For example, when the second difference at the time of returning falls within the large value area, management server 100 sets a discount rate A(3) of 5%. On the other hand, when the second difference at the time of returning falls within the medium value area, management server 100 sets a discount rate A(3) of 2%. On the other hand, when the second difference at the time of returning falls within the small value area, management server 100 sets a discount rate A(3) of 0%.

Returning to FIG. 3, in S112, management server 100 sets the rental fee. Specifically, management server 100 multiplies the rental fee per unit time by the utilization period so as to calculate the yet-to-be-discounted rental fee. Management server 100 calculates a discount amount by multiplying the calculated yet-to-be-discounted rental fee by a total of discount rates A(1) to A(3). Management server 100 sets the rental fee by subtracting the calculated discount amount from the yet-to-be-discounted rental fee.

Management server 100 may perform a billing process for billing the set rental fee to the user, management server 100 may perform a settlement process for settling up the rental fee if the user has selected automatic payment using information such as a credit card registered in advance, or management server 100 may notify the renal fee and the discount rate to user terminal 500. On this occasion, management server 100 may notify details of discount rates A(1) to A(3) to user terminal 500, for example.

<As to Operation of Management Server 100 Serving as Information Processing Device>

An operation of management server 100 which is an information processing device based on the above configuration and flowchart will now be described. For example, it is assumed that vehicle 200 is rented to a user and the renting date and time is stored in storage 104 upon the renting process.

When vehicle 200 is returned to station 150 by the user (YES in S100), management server 100 specifies the return date and time and the user (S102) and obtains the return station information (S104).

Based on the obtained information, management server 100 sets discount rate A(1) corresponding to the first difference obtained by subtracting the number of parked low-SOC vehicles from the number of electric vehicles that can be charged (S106), sets discount rate A(2) corresponding to the prediction of increase or decrease of the number of electric vehicles parked at the time of returning (S108), and sets discount rate A(3) corresponding to the second difference obtained by subtracting the number of electric vehicles parked at the time of returning from the number of electric vehicles that can be parked (S110).

Management server 100 multiplies the rental fee per unit time by the utilization period so as to calculate the yet-to-be-discounted rental fee, and multiplies the calculated yet-to-be-discounted rental fee by the total of discount rates A(1) to A(3) so as to calculate a discount amount. Management server 100 sets, as the rental fee, a fee obtained by subtracting the discount amount from the yet-to-be-discounted rental fee (S112).

<As to Function and Effect of Information Processing Device>

As described above, according to the information processing device according to the present embodiment, as there are more availabilities for the charging stands in the return station, the rental fee becomes smaller, thereby motivating the user to set such a station as a return location for the electric vehicle. As a result, the user drives the electric vehicle to a station with availabilities for charging stands, whereby the power storage device mounted in the returned electric vehicle can be charged immediately. Accordingly, the utilization ratio can be suppressed from being decreased, while suppressing uneven distribution of vehicles among the stations. Accordingly, there can be provided an information processing device and an information processing method each for setting a rental fee of an electric vehicle to suppress decrease of a utilization ratio while suppressing uneven distribution of electric vehicles among stations when renting the electric vehicles.

Further, when the number of electric vehicles after the time of returning is predicted to be decreased, the station is predicted to be in the sparsely parked state. Hence, by setting the rental fee to be smaller than the rental fee set when the number of electric vehicles is predicted to be increased, the user can be motivated to set such a station as a destination of the electric vehicle.

Further, by setting a smaller rental fee for a user who drives an electric vehicle to a station in the sparsely parked state at the time of returning of the electric vehicle, the user can be motivated to drive the electric vehicle to the station in the sparsely parked state.

<As to Modifications>

In the above-described embodiment, it has been described that the discount rate is set for the yet-to-be-discounted rental fee calculated by multiplying the rental fee per unit time by the utilization period; however, it is not particularly limited to the setting of the discount rate as long as the fee is substantially discounted. For example, instead of the discount rate, a fee returning rate may be set and applied to provide the user with a rebate by cash, a voucher or a variety of types of points.

Further, in the above-described embodiment, it has been described that each of discount rates A(1) to A(3) for calculating a discount amount is calculated; however, the setting of at least one of discount rates A(2) and A(3) may be omitted as long as at least discount rate A(1) is set.

Further, in the above-described embodiment, it has been described that the discount rate is set in accordance with the first difference obtained by subtracting the number of low-SOC vehicles from the number of charging stands in the return station; however, for example, the discount rate may be set in accordance with a difference obtained by subtracting the number of low-SOC vehicles from the number of quick charging stands, or the discount rate set in accordance with the first difference may be corrected in accordance with a correction coefficient set based on the number of quick charging stands.

Further, in the above-described embodiment, it has been described that the increase or decrease in the number of parked electric vehicles after the time of returning is predicted based on the number of electric vehicles scheduled to leave and the number of electric vehicles scheduled to enter until passage of the predetermined period from the time of returning; however, for example, the number of electric vehicles scheduled to leave and the number of electric vehicles scheduled to enter may be corrected in consideration of a season or a past history such as the corresponding month or day of the previous year.

Further, in the above-described embodiment, it has been described that each of discount rates A(1) to A(3) is set in accordance with a situation of the return station when calculating the rental fee at the time of returning of the electric vehicle; however, for example, when making a reservation for renting of an electric vehicle, each of discount rates A(1) to A(3) may be set in accordance with a prediction result (for example, the number of parked electric vehicles, the number of parked low-SOC vehicles, or the like, which are calculated from the reservation list) of a situation of the station to which the electric vehicle is scheduled to be returned, and the set discount rate may be notified to the user.

Alternatively, when making a reservation, management server 100 may calculate each of discount rates A(1) to A(3) in each of a plurality of stations near the station to which the electric vehicle is scheduled to be returned, and may notify a station for which the fee becomes smaller than the fee in the case where the electric vehicle is returned to the station to which the electric vehicle is scheduled to be returned.

Specifically, when a reservation via user terminal 500 is received, based on the reservation information transmitted from user terminal 500, management server 100 may calculate (i) a total of discount rates A(1) to A(3) in the station to which the electric vehicle is scheduled to be returned, and (ii) a total of discount rates A(1) to A(3) in each of a plurality of stations near the station to which the electric vehicle is scheduled to be returned (for example, the predetermined number of stations in the order from the one closest to the station to which the electric vehicle is scheduled to be returned), and then may notify, to user terminal 500, an estimate of each of the rental fees involving the discount rates of the stations.

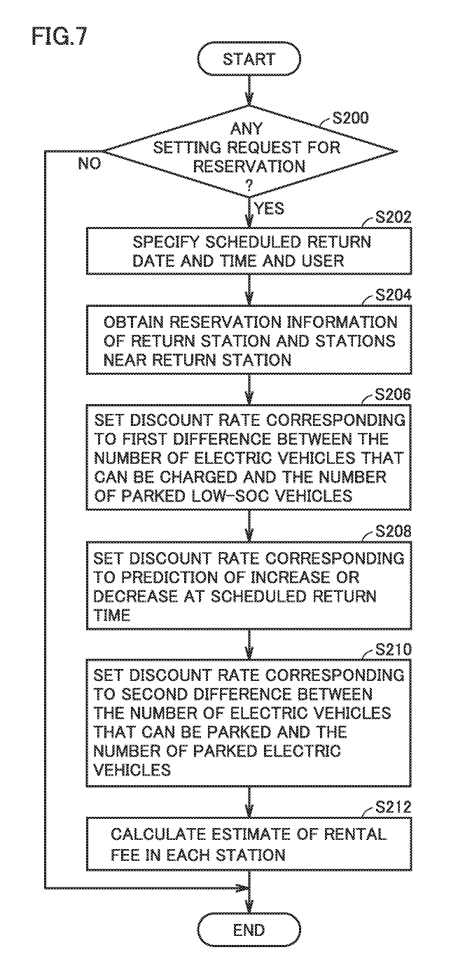

The following describes a reservation receiving process in detail with reference to FIG. 7. FIG. 7 is a flowchart showing the reservation receiving process. In the present embodiment, the reservation receiving process will be described as being executed by management server 100 (more specifically, CPU 102 of management server 100) for the sake of illustration. While each step shown in the flowchart shown in FIG. 7 is implemented by software processing done by management server 100, a part thereof may be implemented by hardware (or electric circuitry) fabricated in management server 100.

In S200, management server 100 determines whether or not there is a setting request for reservation. For example, management server 100 determines that there is a setting request for reservation, when a signal indicating reservation information is received from user terminal 500. When it is determined that there is a setting request for reservation (YES in S200), the process proceeds to S202. For example, the reservation information includes: information for specifying the user (user ID or the like); information for specifying a station serving as a departure location; information for specifying a return station; information about scheduled date and time of start of utilization; and information about the scheduled return date and time.

In S202, management server 100 specifies the scheduled return date and time and the user. Specifically, management server 100 obtains the scheduled return date and time and the user ID from the received reservation information, thereby specifying the scheduled return date and time and the user.

In S204, management server 100 obtains information of the return station and information of a plurality of stations near the return station. The information of the return station is information for specifying the location of the return station, and is obtained from the reservation information. Management server 100 specifies the plurality of stations near the return station based on the obtained information of the return station. For example, management server 100 specifies the predetermined number of stations in the order from the one closest to the return station.

In S206, management server 100 sets discount rate A(1) corresponding to the first difference between the number of electric vehicles that can be charged and the expected number of parked low-SOC vehicles on the scheduled return date and time. For example, based on the reservation list, management server 100 calculates the expected number of parked low-SOC vehicles on the scheduled return date and time. Management server 100 sets (i) the discount rate in the return station and (ii) the discount rate in each of the plurality of stations specified in S204. It should be noted that the details of the setting of the discount rate are the same as those of the process of S106 of the flowchart shown in FIG. 3. Accordingly, detailed description thereof will not be repeated.

In S208, management server 100 sets discount rate A(2) corresponding to prediction of increase or decrease of the number of parked electric vehicles on the scheduled return date and time. For example, management server 100 makes reference to respective reservation statuses of the return station and the plurality of stations specified in S204 in the reservation list, so as to predict increase or decrease of the number of parked electric vehicles on the scheduled return date and time by comparing (i) the number of electric vehicles scheduled to leave until passage of a predetermined period from the scheduled return date and time with (ii) the number of electric vehicles scheduled to enter until the passage of the predetermined period from the scheduled return date and time. It should be noted that the setting of the discount rate based on the prediction result of the increase or decrease is the same as those of the process of S108 of the flowchart shown in FIG. 3. Accordingly, detailed description thereof will not be repeated.

In S210, management server 100 sets discount rate A(3) corresponding to a second difference between the number of electric vehicles that can be parked in the return station and the number of parked electric vehicles in the return station. Management server 100 calculates: a discount rate in the return station; and a discount rate in each of the plurality of stations specified in S204. It should be noted that the details of the setting of the discount rate are the same as those of the process of S108 of the flowchart shown in FIG. 3. Accordingly, detailed description thereof will not be repeated.

In S212, management server 100 calculates respective estimates of the rental fees in the return station and the plurality of stations specified in S204, and transmits each of the calculated estimates to user terminal 500. Management server 100 multiplies the rental fee per unit time by the scheduled utilization period so as to calculate the yet-to-be-discounted estimate, and multiplies the estimate by the total of discount rates A(1) to A(3) to calculate a discount amount. Management server 100 sets the discounted estimate by subtracting the discount amount from the yet-to-be-discounted estimate. Management server 100 transmits, to user terminal 500, a signal indicating the set discounted estimate. When user terminal 500 receives the signal indicating the estimate, user terminal 500 presents the estimate in each station on touch panel display 506. It should be noted that each of the estimates in the plurality of stations specified in S204 may be presented only when each of the estimates in the plurality of stations is smaller than the estimate in the return station.

As described above, in the reservation receiving process, for example, when there is a setting request for reservation from user terminal 500 (YES in S200), the scheduled return date and time and the user are specified (S202) and the information of the return station and the stations near the return station is obtained (S204). In each station, the discount rate corresponding to the first difference is set (S206), the discount rate corresponding to the prediction of increase or decrease of the number of electric vehicles at the scheduled time of returning is set (S208), the discount rate corresponding to the second difference is set (S210), and the estimate of the rental fee in each station is notified to user terminal 500 (S212).

In this way, the user can be motivated to return the electric vehicle to a station predicted to be in the sparsely parked state in a closing period of the scheduled utilization period.

It should be noted that the above modifications may be implemented all together or may partially be implemented in combination.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. An information processing device for setting a rental fee of an electric vehicle in which a power storage device is mounted, the information processing device comprising:
a storage configured to store a first difference, the first difference being obtained by subtracting (i) the number of electric vehicles that are parked in a return station at a time of returning of the electric vehicle and that have power storage devices required to be charged, from (ii) the number of charging devices that are installed in the return station and that are configured to charge the power storage devices, the return station being a station to which the electric vehicle is returned among a plurality of stations serving as sites for renting electric vehicles; and
a setting device configured to set the rental fee of the electric vehicle, wherein
when the first difference is larger than a predetermined number, the setting device is configured to set the rental fee to be smaller than the rental fee set when the first difference is smaller than the predetermined number.

2. The information processing device according to claim 1, wherein
the setting device is configured to predict increase or decrease of the number of electric vehicles to be parked in the return station after the time of returning, and
when the number of electric vehicles to be parked in the return station after the time of returning is predicted to be decreased, the setting device is configured to set the rental fee to be smaller than the rental fee set when the number of electric vehicles to be parked in the return station after the time of returning is predicted to be increased.

3. The information processing device according to claim 1, wherein
the storage is configured to further store a second difference, the second difference being obtained by subtracting (i) the number of electric vehicles parked at the time of returning from (ii) the number of electric vehicles that can be parked in the return station, and
when the second difference is larger than a predetermined number, the setting device is configured to set the rental fee to be smaller than the rental fee set when the second difference is smaller than the predetermined number.

4. The information processing device according to claim 1, further comprising:
a reservation receiving device configured to receive an reservation for renting the electric vehicle for a scheduled utilization period; and
a notifying device configured to notify, in a closing period of the scheduled utilization period, a station which is included in a plurality of stations near the return station and for which the rental fee is predicted to be smaller than the rental fee set when the electric vehicle is returned to the return station.

5. An information processing method for setting a rental fee of an electric vehicle in which a power storage device is mounted, the information processing method comprising:
storing a first difference, the first difference being obtained by subtracting (i) the number of electric vehicles that are parked in a return station at a time of returning of the electric vehicle and that have power storage devices required to be charged, from (ii) the number of charging devices that are installed in the return station and that are configured to charge the power storage devices, the return station being a station to which the electric vehicle is returned among a plurality of stations serving as sites for renting electric vehicles;
setting the rental fee of the electric vehicle; and
when the first difference is larger than a predetermined number, setting the rental fee to be smaller than the rental fee set when the first difference is smaller than the predetermined number.

6. An information processing device for setting a rental fee of an electric vehicle in which a power storage device is mounted, the information processing device comprising a setting device configured to set the rental fee of the electric vehicle, wherein
the setting device is configured to obtain the number of charging devices installed in a return station and configured to charge the power storage device, the return station being a station to which the electric vehicle is returned among a plurality of stations serving as sites for renting electric vehicles,
the setting device is configured to calculate a first difference, the first difference being obtained by subtracting (i) the number of electric vehicles that are parked in the return station at a time of returning of the electric vehicle and that have power storage devices required to be charged, from (ii) the number of the charging devices, and
when the first difference is larger than a predetermined number, the setting device is configured to set the rental fee to be smaller than the rental fee set when the first difference is smaller than the predetermined number.
